(19) United States
(12) Patent Application Publication
(10) Pub. No.: US 2016/0035008 A1
(43) Pub. Date: Feb. 4, 2016

(54) Allowing a Customer to Select Vehicle Services Prior to Visiting a Service Center

(71) Applicant: John Griffin, Layton, UT (US)

(72) Inventor: John Griffin, Layton, UT (US)

(21) Appl. No.: 14/449,042

(22) Filed: Jul. 31, 2014

(51) Int. Cl. G06Q 30/06; H04L 29/08; G06Q 30/00; G06F 3/0484

(52) U.S. Cl. CPC G06Q 30/0635; G06F 3/04842; H04L 67/02; G06Q 30/012

(57) ABSTRACT

A customer is allowed to select vehicle services prior to visiting a service center. A customer can access a website or mobile application to provide input identifying a vehicle to be serviced. A number of possible services that can be performed on the identified vehicle can then be presented including, in some cases, an estimated cost for such services. The customer may then select one or more services to be performed. In response, the website or mobile application can generate a purchase order that the customer can present to a technician once arriving at the service center thereby allowing the technician to commence work immediately on the vehicle. A vehicle may also be automatically enrolled in a warranty program. The actions required to comply with the warranty program as well as estimated dates when the actions should be performed can be automatically determined.

### CROSS-REFERENCE TO RELATED APPLICATIONS

This application is related to U.S. patent application Ser. No. 14/272,388 (the '388 application) titled Presenting Service Options Using A Model Of A Vehicle which was filed on May 7, 2014. The '388 application is incorporated herein by reference.

### BACKGROUND

Many vehicle service centers provide services without requiring that the customer make an appointment. In order to meet customer expectations in such situations, it is important that the services be provided quickly. However, it can oftentimes be difficult to quickly identify services that may need to be performed on a vehicle.

For example, once a customer brings a vehicle in to a service center, the vehicle must be pulled into a service stall to allow a technician to inspect the condition and various systems and components of the vehicle. As the technician performs this inspection, he will typically write down a list of potential services that are recommended. The recommended services can be based on the condition of the vehicle as well as on the manufacturer's recommendations which may be independent of the condition of the vehicle.

After the inspection is performed and the list of potential services is compiled, the technician will typically pass the list to a manager that will discuss the potential services with the customer to allow the customer to select which services to have performed. Usually these potential services will be separated as either services recommended based on the condition of the vehicle or services recommended by the manufacturer. This list of potential services is oftentimes long and tedious for the customer to review. Finally, the manager will inform the technician of which services the customer selected to allow the technician to begin performing the services. The manager typically informs the technician using written or verbal communication which can oftentimes result in mistakes.

If this process of identifying recommended services and receiving the customer's selection of services to perform takes too long, the customer can become dissatisfied with the service center even if the selected services are ultimately performed in a satisfactory manner. In some cases, this dissatisfaction can cause the customer to bypass the inspection process in future visits and instead elect to have only a specific and predetermined service performed such as an oil change. This may result in various problems with the vehicle going undetected until more costly services or repairs are required, and also eliminates the service center's opportunity to perform additional services.

### BRIEF SUMMARY

The present invention extends to methods, systems, and computer program products for allowing a customer to select vehicle services prior to visiting a service center. A customer can access a website or mobile application to provide input identifying a vehicle to be serviced. In some cases, a vehicle identification number (VIN) scanner can be employed to provide the input. The website or mobile application can then present a number of possible services that can be performed on the identified vehicle including, in some cases, an estimated cost for such services. These possible services can include services that are recommended based on the VIN of the identified vehicle. The customer may then select one or more services to be performed. In response, the website or mobile application can generate a purchase order that the customer can present to a technician once arriving at the service center thereby allowing the technician to commence work immediately on the vehicle.

In one embodiment, the present invention is implemented as a method for allowing a customer to select vehicle services prior to visiting a service center. A customer interface is presented to a customer. The customer interface includes a plurality of services that are available to be performed on a vehicle of the customer at a service center. Input is received from the customer that selects one or more of the services. In response to the selection of the one or more services, a work order is provided to the customer to allow the customer to present the work order upon visiting the service center. The work order identifies the one or more selected services.

In another embodiment, the present invention is implemented as a method for allowing a customer to select vehicle services prior to visiting a service center. Input is received that identifies a vehicle of the customer. The input is received from the customer prior to the customer visiting a service center. A plurality of services are identified that are available to performed on the vehicle at the service center. The plurality of services are identified based on the identity of the vehicle. The plurality of services are presented within a customer interface. Input is received that selects at least one of the plurality of services. A work order is generated that identifies the at least one selected service. The work order is displayable to allow the customer to present the work order upon visiting the service center.

In another embodiment, the present invention is implemented as a method for allowing a customer to select vehicle services prior to visiting a service center. Input is received that identifies a vehicle of the customer. The input is received from the customer prior to the customer visiting a service center. A plurality of services are identified that are available to performed on the vehicle at the service center. The plurality of services are identified based on the identity of the vehicle. An estimated cost to perform at least one of the plurality of services is identified. The estimated cost is based on the identity of the vehicle. The plurality of services are presented within a customer interface including the estimated cost for the at least one service. Input is received that selects at least one of the plurality of services. A work order is generated that identifies the at least one selected service. The work order is presentable to allow the customer to present the work order upon visiting the service center.

In another embodiment, the present invention is implemented as a method for assisting a customer to comply with a warranty program. An average number of miles that a vehicle is driven is calculated. A warranty program that the vehicle is enrolled is identified including identifying one or more actions that must be performed on the vehicle to comply with the warranty program. The one or more actions each identify a mileage of the vehicle. The warranty program requires that the one or more actions be performed on the vehicle prior to the vehicle reaching the identified mileage. The average number of miles is used to estimate a future date on which the vehicle will reach the mileage identified for a particular action. A reminder is stored in association with an account of the customer. The reminder indicates that the particular action should be performed prior to the future date estimated for the particular action.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIG. 2 illustrates how a mobile device can be used to scan a vehicle's VIN barcode to retrieve the vehicle's VIN; and

FIG. 3 provides a flowchart of an example method for allowing a customer to select vehicle services prior to visiting a service center

### DETAILED DESCRIPTION

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

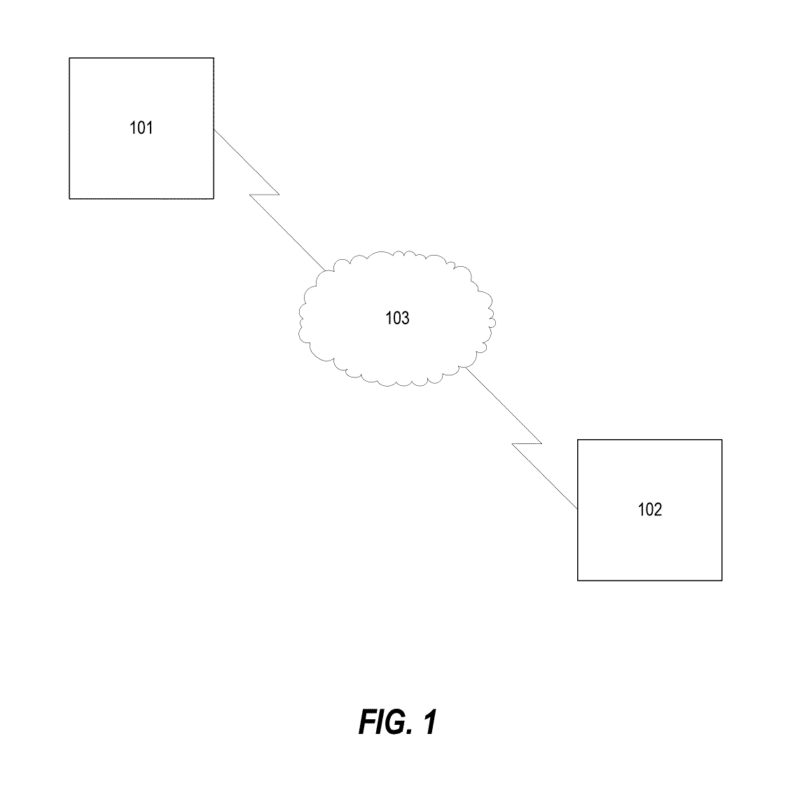

FIG. 1 illustrates an example computer environment 100 in which the present invention can be implemented. Computer environment 100 includes a server system 101 and a client device 102 that are interconnected by a network. Server system 101 can represent any number or arrangement of computing components (whether software and/or hardware) that can function as a server including cloud configurations. Server system 101, in some embodiments, may comprise multiple different computing devices located at different locations such as a service center and another location. Client device 102 can represent any type of device which a customer may use to access functionality provided by server system 101. For example, client device 102 can be a desktop computer, a tablet, a mobile phone, a television, a media or gaming device, etc.

In some embodiments, server system 101 can provide a website accessible to client device 102 on which a customer can access the functionality described below. In other embodiments, server system 101 can enable the use of a mobile application or other dedicated application that executes on client device 102 which can provide the functionality described below by interacting with server system 101. In the remainder of this specification, the interface through which the customer interacts with the functionality provided or enabled by server system 101 will be referred to as the customer interface.

In accordance with one or more embodiments of the invention, a customer may access the customer interface to select vehicle services prior to visiting a service center. Initially, the customer interface may allow a customer to provide input identifying a vehicle to be serviced. For example, the customer interface may include fields into which the customer can input a VIN, license plate number, mileage, and/or the make, model, and year of a vehicle. The customer interface may also include fields into which the customer can input his name, contact information, or other information useful for creating an account with server system 101.

An account can be created that includes one or more vehicles. For example, an account may be created for a household that includes each vehicle that a family owns. When an account is used and the customer is logged in, the customer interface can present each vehicle associated with the account in the customer interface to allow the customer to select a vehicle for which services are to be presented as will be further described below.

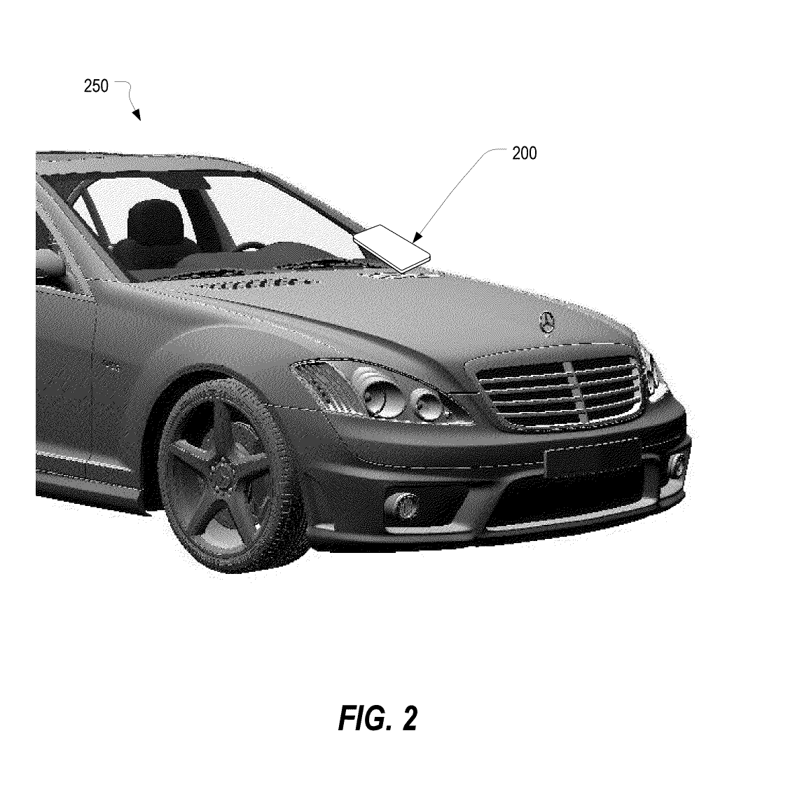

In some embodiments, the customer interface may provide functionality for receiving a VIN via a VIN scanner. FIG. 2 illustrates an example of how a VIN scanner of a client device 200 can be used to automatically provide a vehicle 250's VIN to server system 101 and/or the customer interface. FIG. 2 represents an embodiment where the customer interface is provided as a mobile application or website executing on a tablet, smart phone, or similar client device having a camera that can be used to scan a VIN. The customer interface may prompt the customer to input a VIN of a vehicle and provide an option to do so by scanning the VIN with a camera of client device 200. Then, as shown, the customer may position client device 200 above the VIN of vehicle 250 so that the camera is facing the VIN. The VIN scanner can be configured to interface with the camera to obtain an image of the VIN and to automatically identify the VIN from the image. Once the VIN has been identified, it may automatically be sent to server system 101 or may be populated into the customer interface for later submission to server system 101. The VIN scanner functionality can be provided as part of a mobile application or may be incorporated into a webpage.

In other embodiments where the client device on which the customer interface is presented is not capable of implementing a VIN scanner (e.g. a desktop computer), the customer interface may be configured to communicate with another device that is capable of implementing the VIN scanner. For example, while accessing the customer interface as a website on a desktop computer, the customer may be prompted to use his mobile phone to scan the VIN of his vehicle. The customer interface may provide instructions for downloading a VIN scanning application that can be used on the customer's mobile phone or tablet to scan the VIN and then communicate the VIN to server system 101. For example, the VIN scanning application can associate the scanned VIN with a customer (e.g. using an account identifier) to enable server system 101 to identify that it is the VIN of the customer's vehicle.

Whether the VIN is sent to server system 101 using the same device or a different device than the device being used to view the customer interface, or whether the customer manually inputs the VIN or other identifying information, server system 101 can use the VIN or other identifying information to select services to be presented to the customer in the customer interface. For example, some services available at a service center may not be appropriate for certain vehicles. Server system 101 can use the vehicle's identity to identify which, if any, of the available services are not appropriate and not present those services in the customer interface. Also, server system 101 can use the vehicle's identity to identify services that are recommended for the vehicle such as, for example, based on manufacturer recommendations.

In some instances, server system 101 may present some services regardless of the identity of the vehicle. For example, an oil change service, a tire rotation service, a windshield wiper replacement service, etc. may always be presented in customer interface since these types of services are generally applicable to all vehicles.

If server system 101 has stored information about previous services that were performed on the identified vehicle (e.g. if the customer has already had services performed at a service center associated with server system 101), server system 101 can use this stored information to identify which services to recommend or not to recommend. For example, if an oil change was recently performed on the vehicle, an oil change service may not be recommended. In such cases, customer interface can display an indication that the oil change service was already performed and is not required until a later time or alternatively may not display the oil change service.

In some embodiments, server system 101 may distinguish between services that are recommended and those that are available. As described above, by knowing the identity of the vehicle, server system 101 can identify various services that are recommended for a particular vehicle such as based on the age, mileage, registration date, etc. of the vehicle. Customer interface may present such recommended services first or otherwise highlight them to distinguish them from other services that are available but for which there is no particular reason to recommend them. For example, if a transmission service is recommended at 60,000 miles and, based on the identity of the vehicle, it is determined that the vehicle has 58,000 miles, server system 101 may identify the transmission service as a recommended service. Similarly, if a manufacturer has recommended a repair to the vehicle, a repair service can be recommend.

In some embodiments, server system 101 may further identify services that may not be recommended immediately but will be recommended in the near future. Using the transmission service example, if the vehicle had 55,000 miles, server system 101 may determine not to recommend that the transmission service be immediately performed, but may identify a future date when the transmission service should be performed. In such cases, the customer interface may provide the customer with an option to request a reminder as the future date approaches or with an option to schedule the service at a future date.

In cases where server system 101 knows the identity of the customer's vehicle, server system 101 can present available services with an estimated cost that are specific to the particular vehicle. Service centers typically do not advertise specific prices for many services because the cost of performing such services may vary based on the vehicle. For example, an oil change service may be more expensive for a truck than for a compact car because the truck requires more oil or a different type of oil. By knowing the identity of the vehicle, server system 101 can provide the customer with an accurate estimate of the cost for performing a service.

In some embodiments, the estimate for performing a service can be specific to a particular service center. For example, many service center chains vary their pricing based on the location of the service center. The present invention can employ the location of the customer to provide estimates that are specific to a nearby or a requested service center. These estimates can incorporate the tax required for the service based on the location of the service center (i.e., the estimate can incorporate the city, county, and state taxes for the location of the service center). Therefore, the estimate given to the customer, assuming the information on which it is based is correct, is an actual price for performing the service.

Regardless of how the available services are presented, the customer interface can allow the customer to select one or more services to have performed when the customer visits a service center. In some embodiments, the customer interface may also present a list of service centers that the customer may visit such as a number of service centers within a specified distance of a customer's address or current location. In some embodiments, the service centers that are presented to the customer can be filtered based on which services the customer has selected. For example, if the customer selects a service that cannot be performed at a particular service center, this service center may not be presented in the customer interface.

Once the customer has selected one or more services, the customer interface can allow the customer to create a work order for the selected services. The work order can specify the services selected by the customer so that the customer may present the work order at the service center to allow the service center to immediately commence the services. The customer interface can include an option to print a hard copy of the work order or may provide an option to display the work order on a client device such as a mobile phone.

In some embodiments, the work order can comprise a bar code or other electronically scannable or identifiable element. For example, if the customer interface is provided as a mobile application, the mobile application may be configured to display a bar code that can be scanned at the service center. The mobile application may also be configured to transmit the work order to the service station upon customer arrival (e.g. via RFID, NFC, Bluetooth, etc.). Alternatively, the customer interface may enable the work order to be emailed, texted, or otherwise transmitted so that the work order can be electronically displayed on another computing device for scanning at the service center.

By providing a work order that the customer can bring to the service center, the present invention facilitates the selection of services prior to visiting the service center. For example, a father may use the customer interface to select services to be performed on his wife's or child's vehicle. The father can receive the work order for the selected services and provide it to his wife or child. The wife or child may then present the work order upon visiting the service center thereby relieving the wife or child from having to select the services.

Once the work order is scanned or otherwise identified by the service station, a work order may be auto populated in the service center's computing system (which may be part of server system 101). For example, once the customer's work order is scanned, the customer's vehicle may be automatically entered in a queue with an indication of the services that the customer had selected. This information that is auto populated may be transmitted from server system 101 to the service center's computing system or may be embedded in the electronically scannable or identifiable element. For example, a bar code may include information identifying each service that the customer selected, the VIN or other information identifying the vehicle, and/or information identifying the customer. In other embodiments, the element may include an identifier that is sufficient to enable the computing system to retrieve the selected services from information stored on or provided by server system 101.

In some embodiments, prior to creating the work order, the customer interface can allow the customer to input payment information such as a credit card. Server system 101 may use the payment information to immediately charge the customer for the selected services, or may store the payment information and charge the customer once the services are performed.

While or after the technicians of the service center perform the selected services, they may enter information into a computing system identifying the services that were performed, any recommendations they may have for the vehicle (e.g. based on an inspection), any preexisting condition that the vehicle may have prior to visiting the service center (e.g. existing damage to the vehicle), or any other notes. This information can be routed back to server system 101 to be associated with the customer's account thereby allowing the customer to review such information at a later time such as via the customer interface. Additionally, server system 101 can use this information to customize which services are presented or recommended to the customer while using the customer interface.

In some embodiments, the technicians can perform an inspection of the customer's vehicle and present recommended services based on the inspection. The '388 application describes various embodiments for how a customized model of the customer's vehicle can be generated and presented to the customer to identify services that are recommended.

The use of a customized model to present recommended services can be employed in embodiments of the present invention. For example, a mobile application that displays the customer interface may also be configured to display a customized model of the customer's vehicle. In such cases, while the customer waits for his vehicle to be serviced, the technician can create the customized model which can be provided to the mobile application for presentation to the customer. In other embodiments, a separate computing device may be used to present the customized model to the customer. For example, a tablet provided at the service center may be used.

In some embodiments, a customer survey may be presented to the customer while or after the selected services are performed. This customer survey can be presented in the customer interface (e.g. on the customer's computing device) or on a separate computing device such as a tablet provided by the service center. This customer survey can ask the customer to provide feedback on the visit to the service center and/or on his experience with the customer interface.

In some embodiments, the customer may be requested to provide unique input to validate the feedback. The provision of unique input can prevent an employee of the service center from providing fake feedback. As an example, the service center may provide a computing device that includes a card reader so that the customer can scan his credit card as part of completing the customer survey. The computing device can be configured to read the name, address, phone number, or other information from the credit card in a manner that would be difficult to manually reproduce without the credit card. In other words, the information obtained from the credit card will typically be different from or more detailed than the information, such as name, address, and phone number, that a technician may otherwise have access to. Requiring receipt of the information from the credit card will therefore verify that the technician did not complete the survey himself since it would be much more difficult for the technician to obtain a customer's credit card to complete the customer survey without the customer knowing. Therefore, this information can be stored with the customer survey to indicate that the feedback was legitimately received from the customer.

In some embodiments, the customer survey feedback can be used to provide real-time updates to employees and managers. For example, if the feedback from multiple customers indicates that the wait time is too long, a real-time update can be provided to assist the manager to quickly address the problem. By having the customers complete the customer survey while waiting at the service center, the provision of real-time updates can be facilitated. Also, in some embodiments, to encourage customers to complete the customer survey, free access to tablets or other computing devices can be provided. For example, the service center may provide a number of tablets that customers can use after having completed the customer survey. In other embodiments, customers may be allowed to use the tablets without completing the survey, but may be prompted to complete the survey during use or may be given an incentive to complete the customer survey such as a discount on the current services or future services.

Once the services have been completed on the customer's vehicle, the customer interface may be configured to receive and display a receipt summarizing the services that were performed along with any amount paid for the services. Server system 101 may be configured to store such receipts to allow the customer to retrieve them at a later time.

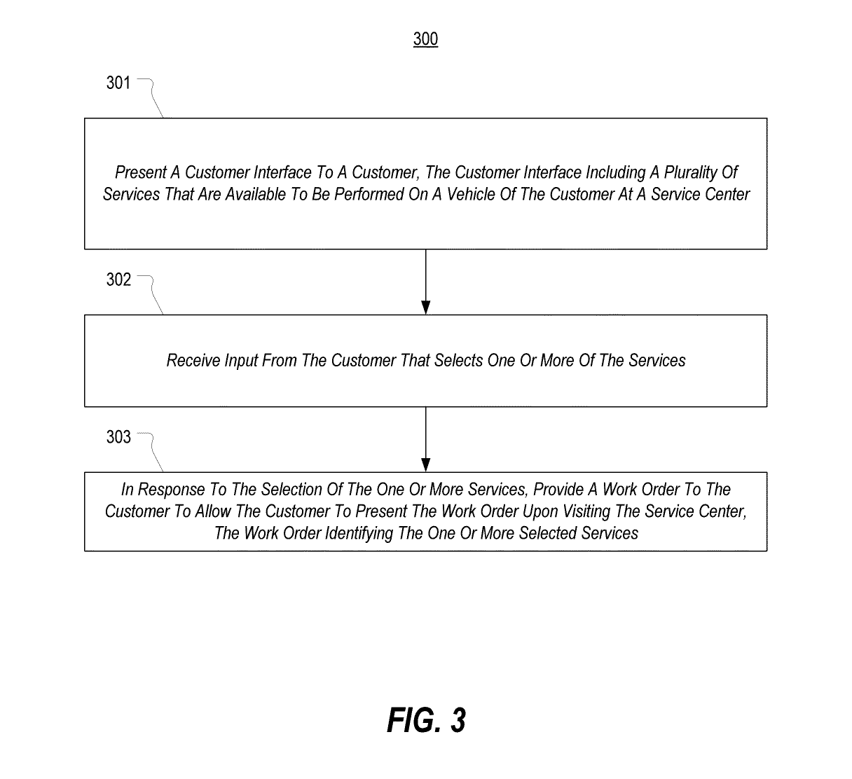

FIG. 3 illustrates a flowchart of an example method 300 for allowing a customer to select vehicle services prior to visiting a service center. Method 300 will be described with reference to the computer environment 100 of FIG. 1.

Method 300 includes an act 301 of presenting a customer interface to a customer, the customer interface including a plurality of services that are available to be performed on a vehicle of the customer at a service center. For example, server system 101 can send a customer interface, or data for generating the customer interface, to client device 102.

Method 300 includes an act 302 of receiving input from the customer that selects one or more of the services. For example, server system 101 can receive input from client device 102 that identifies one or more services that the customer selected by interacting with the customer interface displayed on client device 102.

Method 300 includes an act 303 of, in response to the selection of the one or more services, providing a work order to the customer to allow the customer to present the work order upon visiting the service center, the work order identifying the one or more selected services. For example, server system 101 can generate and provide a work order to client device 102 to allow the customer to present the work order at a service center such as by displaying the work order on client device 102 or another device or by printing the work order.

In some embodiments, the present invention may also facilitate enrolling a vehicle in a warranty program and assist the customer in complying with the required warranty structure of the warranty program. As described above, information about a vehicle can be obtained directly from the customer or by a technician (e.g., via a VIN scanner or manual input). This information can include the vehicle's VIN, mileage, and license plate. In some embodiments, the VIN can be used to obtain the year, make and model of the vehicle, the license plate can be used to determine how many owners the vehicle has had, and the mileage can be used to determine which warranty programs the vehicle qualifies for.

Once this information is obtained, one or more user interfaces can be displayed to the customer (e.g., on client device 102 or on another device accessible to the customer). These user interfaces can prompt the customer to provide additional information to be used in determining whether the vehicle qualifies for a warranty. For example, the customer can be prompted to specify the date the vehicle was purchased.

With the information received from the customer, the present invention can access various sources to determine whether the vehicle qualifies for various types of warranties including a manufacturer warranty, a service center warranty, and a product warranty. The manufacturer warranty can cover the components of the vehicle provided by the manufacturer as part of the vehicle as originally sold such as the drive train. The service center warranty can cover services performed by a service center such as by guaranteeing the services for a period of time. The product warranty can cover products used on or in the vehicle such as oil, windshield wiper blades, air filters, etc.

If it is determined that the vehicle qualifies for any of the warranties based on the information obtained from the customer or otherwise known about the vehicle and is not already enrolled, the vehicle can be automatically enrolled in the warranty program. Automatically enrolling a vehicle can include submitting the necessary information about the vehicle and/or customer to the warranty provider. In some embodiments, however, a vehicle may automatically be enrolled without any action by the customer (e.g., a warranty that applies to a vehicle regardless of who owns the vehicle or when it was purchased).

The present invention may also identify a required warranty structure of any warranty program in which the vehicle is enrolled. The warranty structure can then be added to the customer's account along with any documentation evidencing the enrollment. A warranty structure can comprise the actions that must be performed on a vehicle to maintain the warranty coverage as well as the steps the customer must take to support such actions. A warranty structure can also comprise any limitations on the use of the vehicle.

For example, a manufacturer warranty program covering a drive train of a vehicle up to 100,000 miles may have a warranty structure that requires an oil change every 5,000 miles, a rear differential service every 35,000 miles, a transmission service every 65,000 miles, etc. Similarly, a service center warranty program covering the purchase and installation of tires may have a warranty structure that requires that the vehicle be checked prior to the vehicle hitting 5,000 miles from the date the tires were installed.

The present invention may then calculate an average number of miles a vehicle is driven. This average number can then be used to estimate when the actions required by the warranty program should be performed. In some embodiments, the present invention can review the vehicle's service history to identify the vehicle's mileage at the time of one or more previous services. This mileage as well as the current mileage of the vehicle can be used to calculate the average number of miles the vehicle is driven. In some embodiments, the average number of miles can comprise an average number of miles per day. For example, if a previous service indicates that the mileage of the vehicle was 10,000 and another service performed 90 days after the previous service indicates the mileage of the vehicle was 15,000, the average number of miles per day can be calculated as 5,000/90=55.6 miles/day.

Using this average number of miles per day, the current mileage of the vehicle, and the warranty structure, the present invention can estimate one or more future dates when an action will need to be performed to comply with the warranty structure. Using the same numbers as above, if the warranty structure for a particular warranty requires that a rear differential service be performed at 35,000 miles, the present invention can estimate that the vehicle will reach 35,000 miles in approximately (35,000−15,000)/55.6≈300 days. Based on this estimation, the present invention can create a reminder in the customer's account indicating that the rear differential service should be performed prior to the date that is 300 days from the current date.

In addition to creating the reminder in the customer's account, the present invention may also ask the customer how he would like to be reminded of the required service. For example, the present invention can ask the customer whether he would like to receive an email, text message, phone call, or other communication as the date approaches. In some embodiments, the communication can be sent between 30 and 45 days prior to the estimated date. Additional reminders can be sent at later times. These reminders may also include an indication of one or more service centers that are closest to the customer's location which can perform the required service. The reminders may also include pricing for performing the service as well as an estimated amount of time to perform the service.

Once the vehicle is serviced, the present invention may store a receipt or other proof that the service was performed or that a product was purchased in the customer's account. Most warranty programs require the customer to provide proof that the warranty structure was complied with. By automatically storing a receipt or other proof in the customer's account, the present invention can facilitate preparing the necessary documentation when the customer presents a warranty claim. In some embodiments, the present invention may also allow the customer to manually upload a receipt or other proof from a previously performed service or purchase.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

1. A method, performed by a computer system, for allowing a customer to select vehicle services prior to visiting a service center, the method comprising:
maintaining a first database for storing an entry for each of a plurality of service centers, each entry defining a location of the corresponding service center, a number of services that the corresponding service center provides, and, for each of the number of services, an indication of each type of vehicle on which the corresponding service center can provide the service and an actual price to perform the service;
maintaining a second database for storing an entry for each of a plurality of vehicles, each entry defining a type of the corresponding vehicle along with a service history of the corresponding vehicle, the service history defining one or more services that have previously been performed on the corresponding vehicle and an indication of when each of the one or more services was previously performed;
receiving one or more first requests from a computing device of a customer, the one or more first requests including an identification of a first vehicle of the customer and a location of the customer;
in response to the one or more first requests, accessing the second database using the identification of the first vehicle to obtain a first entry corresponding to the first vehicle, the first entry defining the first vehicle as a first type of vehicle, the first entry further defining at least one first service that was previously performed on the first vehicle and an indication of when each of the at least one first service was previously performed;
accessing the first database using the first type of vehicle and the location of the customer to obtain a plurality of second entries corresponding to a second plurality of service centers, each of the second entries defining a location of the corresponding service center that is within a specified distance from the location of the customer, each of the second entries also defining one or more services that the corresponding service center can provide on the first type of vehicle;
sending one or more first responses to the computing device of the customer, the one or more first responses causing a customer interface to be presented on the computing device of the customer, the customer interface including a plurality of available services that can be performed on the first vehicle, the available services consisting of the services defined in the second entries that can be provided on the first type of vehicle, wherein at least one of the available services is presented with an indication that the available service is recommended based on a comparison of the available service to the at least one first service that was previously performed;
receiving input from the customer that selects one or more of the available services;
identifying, from the second plurality of service centers, one of more service centers that can perform all of the selected one or more available services;
presenting, within the customer interface, each of the one or more identified service centers, each of the one or more identified service centers being presented with the corresponding actual price to have the selected one or more available services performed at the service center;
receiving input from the customer that selects a first service center of the one or more identified service centers, the input also providing payment of the actual price to have the selected one or more available services performed at the first service center; and
in response to the payment of the actual price to have the selected one or more available services performed at the first service center, generating a work order that identifies the selected one or more available services and that identifies that the customer has paid the actual price to have the selected one or more available services performed at the first service center.

2. (canceled)

3. The method of claim 1, wherein the identification of the first vehicle comprises a vehicle identification number (VIN).

4. The method of claim 3, wherein the VIN is input from a VIN scanner.

5. The method of claim 1, wherein at least one of the available services is presented with an indication that the available service is recommended based on an amount of time since one or more of the at least one first service was previously performed.

6. The method of claim 5, wherein the amount of time is determined by accessing manufacturer recommendations for the first type of vehicle.

7. The method of claim 1, wherein each corresponding actual price presented within the customer interface incorporates taxes that are calculated based on the location of the corresponding service center.

8. The method of claim 1, wherein the work order is provided to the customer and comprises a scannable element, the method further comprising:
scanning, at the first service center, the scannable element of the work order.

9. The method of claim 8, wherein the scannable element identifies the selected one or more available services, the method further comprising:
auto populating a service center work order at the first service center with the selected one or more available services.

10. The method of claim 1, further comprising:
receiving, from the first service center, information identifying that the selected one or more available services were performed; and
displaying the information within the customer interface.

11. The method of claim 1, further comprising:
presenting a model of the first type of vehicle to the customer, the model being customized based on an inspection of the first vehicle that was performed at the first service center.

12. (canceled)

13. The method of claim 1, further comprising:
presenting a customer survey to the customer to receive feedback from the customer.

14. The method of claim 1, further comprising:
calculating an average number of miles that the first vehicle is driven;
identifying a warranty program that the first, vehicle is enrolled in including identifying one or more actions that must be performed on the first vehicle to comply with the warranty program, the one or more actions each identifying a mileage of the first vehicle, the warranty program requiring that the one or more actions be performed on the first vehicle prior to the first vehicle reaching the identified mileage;
using the average number of miles to estimate a future date on which the first vehicle will reach the mileage identified for a particular action required to comply with the warranty program; and
storing a reminder in association with an account of the customer, the reminder indicating that the particular action should be performed prior to the future date estimated for the particular action in order to comply with the warranty program.

15. One or more computer storage media storing computer executable instructions which when executed by one or more processors implement a method for allowing a customer to select vehicle services prior to visiting a service center, the method comprising:
maintaining a first database for storing an entry for each of a plurality of service centers, each entry defining a location of the corresponding service center, a number of services that the corresponding service center provides, and, for each of the number of services, an indication of each type of vehicle on which the corresponding service center can provide the service and an actual price to perform the service;
maintaining a second database for storing an entry for each of a plurality of vehicles, each entry defining a type of the corresponding vehicle along with a service history of the corresponding vehicle, the service history defining one or more services that have previously been performed on the corresponding vehicle and an indication of when each of the one or more services was previously performed;
receiving one or more first requests from a computing device of a customer, the one or more first requests including an identification of a first vehicle of the customer and a location of the customer;
in response to the one or more first requests, accessing the second database using the identification of the first vehicle to obtain a first entry corresponding to the first vehicle, the first entry defining the first vehicle as a first type of vehicle, the first entry further defining at least one first service that was previously performed on the first vehicle and an indication of when each of the at least one first service was previously performed;
accessing the first database using the first type of vehicle and the location of the customer to obtain a plurality of second entries corresponding to a second plurality of service centers, each of the second entries defining a location of the corresponding service center that is within a specified distance from the location of the customer, each of the second entries also defining one or more services that the corresponding service center can provide on the first type of vehicle;
sending one or more first responses to the computing device of the customer, the one or more first responses causing a customer interface to be presented on the computing device of the customer, the customer interface including a plurality of available services that can be performed on the first vehicle, the available services consisting of the services defined in the second entries that can be provided on the first type of vehicle, wherein at least one of the available services is presented with an indication that the available service is recommended based on a comparison of the available service to the at least one first service that was previously performed;
receiving input from the customer that selects one or more of the available services;
identifying, from the second plurality of service centers, one of more service centers that can perform all of the selected one or more available services;
presenting, within the customer interface, each of the one or more identified service centers, each of the one or more identified service centers being presented with the corresponding actual price to have the selected one or more available services performed at the service center;
receiving input from the customer that selects a first service center of the one or more identified service centers, the input also providing payment of the actual price to have the selected one or more available services performed at the first service center; and
in response to the payment of the actual price to have the selected one or more available services performed at the first service center, generating a work order that identifies the selected one or more available services and mat identifies that the customer has paid the actual price to have the selected one or more available services performed at the first service center.

16. The computer storage media of claim 15, wherein the identification of the first vehicle comprises a VIN of the first vehicle that is obtained using a VIN scanner.

17. The computer storage media of claim 15, wherein at least one of the available services is presented with an indication that the available service is recommended based on an amount of time since one or more of the at least one first service was previously performed.

18. The computer storage media of claim 15, wherein each corresponding actual price presented within the customer interface incorporates taxes that are calculated based on the location of the corresponding service center.

19. The computer storage media of claim 15, wherein the work order is provided to the customer and comprises a scannable element, the method further comprising:
scanning, at the first service center, the scannable element of the work order.

20. The computer storage media of claim 15, wherein the method further comprises:
calculating an average number of miles that the first vehicle is driven;
identifying a warranty program that the first vehicle is enrolled in including identifying one or more actions that must be performed on the first vehicle to comply with the warranty program, the one or more actions each identifying a mileage of the first vehicle, the warranty program requiring that the one or more actions be performed on the first vehicle prior to the first vehicle reaching the identified mileage;
using the average number of miles to estimate a future date on which the first vehicle will reach the mileage identified for a particular action required to comply with the warranty program; and
storing a reminder in association with an account of the customer, the reminder indicating that the particular action should be performed prior to the future date estimated for the particular action in order to comply with the warranty program.

21. The method of claim 20, wherein calculating an average number of miles that the first vehicle is driven comprises:
identifying a mileage of the first vehicle when a previous service was performed on the first vehicle at a previous time;
identifying a mileage of the first vehicle at a later time;
determining the number of days between the previous time and the later time;
determining the number of miles between the mileage at the later time and the mileage at the previous time; and
dividing the number of miles by the number of days to generate the average number of miles.

22. The method of claim 20, further comprising:
searching one or more databases for warranty programs available to the first vehicle; and
automatically enrolling the first vehicle in one or more warranty programs.

23. The method of claim 20, further comprising:
receiving an indication that a service required by the warranty program was performed; and
storing a receipt or other proof that the service was performed in the account.
